(19) United States
(12) Patent Application Publication
(10) Pub. No.: US 2016/0085001 A1
(43) Pub. Date: Mar. 24, 2016

(54) TOUCH PANEL, LIQUID CRYSTAL DISPLAY DEVICE AND SURFACE MODIFICATION METHOD FOR INFRARED MATERIAL

(71) Applicants: Jiuxia YANG, Beijing (CN); Feng BAI, Beijing (CN); Hongyan LI, Beijing (CN); Yiming ZHAO, Beijing (CN); Bing BAI, Beijing (CN); Xiao SUN, Beijing (CN)

(72) Inventors: Jiuxia YANG, Beijing (CN); Feng BAI, Beijing (CN); Hongyan LI, Beijing (CN); Yiming ZHAO, Beijing (CN); Bing BAI, Beijing (CN); Xiao SUN, Beijing (CN)

(21) Appl. No.: 14/344,213

(22) PCT Filed: Aug. 28, 2013
(86) PCT No.: PCT/CN2013/082488

§ 371 Date: Mar. 11, 2014

(51) Int. Cl. G02B 5/20; G06F 3/041; C09K 11/02; G02F 1/1333

(52) U.S. Cl. CPC G02B 5/208; G02F 1/13338; G06F 3/041; C09K 11/02

(57) ABSTRACT

A touch panel, a LCD device including the touch panel, a surface modification method for an IR material, and a touch panel provided with a component including an IR material obtained via the surface modification method are disclosed. A component including the IR material is disposed in the touch panel.

### FIELD OF THE ART

Embodiments of the invention relate to the field of liquid crystal technologies, more particularly, to a touch panel, a Liquid Crystal Display (LCD) device, a surface modification method for an Infrared (IR) material, and a touch panel provided with a component comprising an IR material obtained via the surface modification method.

### BACKGROUND

With the rapid development of display technologies, people expect display devices to provide display effect with high definition, high contrast ratio and high brightness; moreover, there are more diverse requirements on the functions of the display devices, such as entertaining and healthy functions.

### SUMMARY

Embodiments of the invention provide a touch panel, a LCD device, a surface modification method for an IR material and a touch panel provided with a component comprising the IR material obtained via the surface modification method, so as to emit IR light.

A first aspect of the invention provides a touch panel, wherein a component comprising an infrared (IR) material is disposed in the touch panel.

As an example, the component comprising the IR material is an IR layer made of the IR material.

As an example, the touch panel comprises a cover plate, a touch sense layer and a display unit layer,

wherein the IR layer is disposed between the cover plate and the touch sense layer; and/or

the IR layer is disposed between the touch sense layer and the display unit layer.

As an example, when the IR layer is disposed between the cover plate and the touch sense layer,

the IR layer is disposed on a surface of the touch sense layer that faces the cover plate; or

the IR layer is disposed on a surface of the cover plate that faces the touch sense layer.

As an example, when the IR layer is disposed between the touch sense layer and the display unit layer,

the IR layer is disposed on a surface of the touch sense layer that faces the display unit layer; or

the IR layer is disposed on a surface of the display unit layer that faces the touch sense layer.

As an example, the touch panel further comprises an optical clear resin layer disposed between the IR layer and the touch sense layer.

As an example, the component comprising the IR material comprises at least one of the following components: the cover plate, the touch sense layer, and the display unit layer.

As an example, the IR layer made of the IR material is disposed on all or a part of the surface of the at least one of the cover plate, the touch sense layer, and the display unit layer.

As an example, the touch panel comprises a cover plate, a touch sense layer and a display unit layer, wherein at least one of which is made of a material containing an IR material.

As an example, the IR material is a mixture of one or more of biochar, tourmaline, far-infrared ceramic, jade powder, aluminum oxide, copper(II) oxide, silver(I,III) oxide and silicon carbide.

As an example, a particle size of the IR material is in the order of a nanometer to a micrometer.

As an example, the IR material is surface modified so as to emit IR light when being irradiated.

A second aspect of the invention provides a LCD device comprising a backlight module and the above touch panel.

A third aspect of the invention provides a surface modification method for an IR material, comprising:

nanocrystallizing the IR material to obtain nanoparticles of the IR material; and

modifying surface property of the nanocrystallized nanoparticles such that the nanoparticles are compatible and have matching property with a corresponding structural layer of a liquid crystal cell and emit IR light when being irradiated by light.

As an example, nanocrystallizing the IR material comprises grinding and dispersing the IR material to obtain a dispersion solution of the IR material with an average particle size of 1 nm to 200 nm.

As an example, modifying surface property of the nanocrystallized nanoparticles comprises:

mixing the dispersion solution of the IR material with an organic solvent containing methyl methacrylate, styrene, maleimide and then adding an azo-initiator solution into the mixture; and

after the reaction is finished, adding a cooling organic solvent to cool and stirring until resultant is cooled, then filtering and drying the resultant to obtain the surface modified IR material.

As an example, the molar ratio between methyl methacrylate, styrene and maleimide is 1:1˜2:1˜2, the IR material weights 8˜25% of the total mixture weight; and the azo-initiator solution is added drop by drop with a weight of 1˜5% of total monomer weight.

As an example, an environmental condition for modifying the surface property of the nanocrystallized nanoparticles has a temperature of 35° C.˜60° C. and is in a nitrogen atmosphere;

a reaction time is 30 minutes to 90 minutes;

a temperature of the cooling organic solvent is 5° C. to 10° C.;

cooling is performed till room temperature;

filtering is performed for three times; and

drying is performed for 5 minutes to 20 minutes at 70° C. to 100° C.

A fourth aspect of the invention provides a touch panel, wherein a component comprising an IR material is disposed in the touch panel, the IR material is obtained using the above surface modification method.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 schematically illustrates a configuration of a touch panel in accordance with an embodiment of the invention.

### NUMERAL REFERENCES

1—cover plate; 2—touch sense layer; 3—display unit layer; 4—IR layer.

### DETAILED DESCRIPTION

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

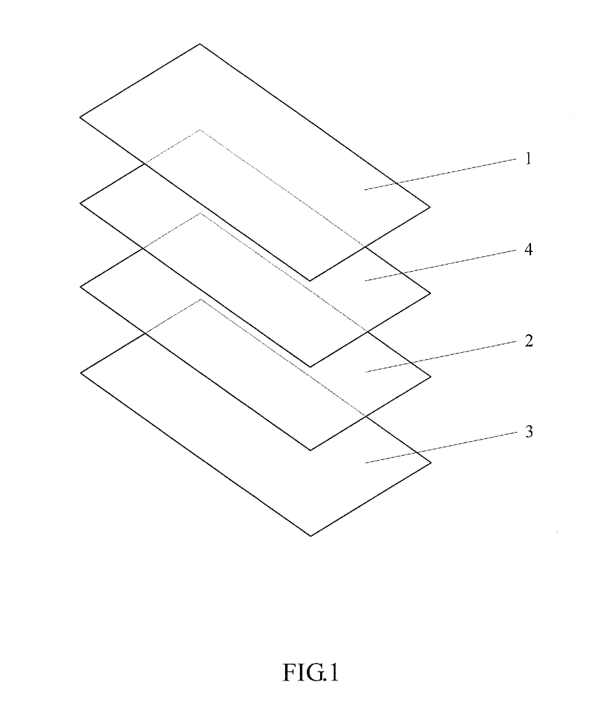

An embodiment of the invention provides a touch panel, which has a component comprising an IR material disposed therein. For example, the component comprising the IR material is an IR layer made of the IR material. It will be described in detail with reference to FIG. 1.

FIG. 1 illustrates a touch panel in accordance with an example of the invention, which comprises a cover plate 1, a touch sense layer 2, a display unit layer 3, and an IR layer 4. The touch sense layer 2 may be a single layer structure provided with a lateral sense electrode, a longitudinal sense electrode and the like. Of course, the touch sense layer 2 may also be a multilayer structure with a lateral sense electrode disposed in one layer and a longitudinal sense electrode disposed in another layer. Moreover, the touch sense layer 2 may be provided with other sensing elements. The display unit layer 3 comprises an element for displaying an image, such as a liquid crystal cell comprising a color filter substrate, liquid crystal and an array substrate, a backlight module, a polarizer, a driver circuit and the like. The touch panel may further comprise an optical clear resin (OCR) layer disposed between the IR layer 4 and the touch sense layer 2. The OCR layer on one hand can increase the light transmittivity, on the other hand can insulate the IR layer 4 and the touch sense layer 2 such that interference is avoided. It can be contemplated that individual components of the touch panel in real applications may be different from that shown in FIG. 1, which is for illustrative purpose only.

In the touch panel shown in FIG. 1, the IR layer 4 comprises a material that generates IR light via heat exchange (abbreviated as IR material). The IR material may absorb energy when being irradiated so as to emit IR light with a wavelength typically of 0.77 μm˜1 mm. Moreover, the intensity of the IR light may be controlled through particle size, surface morphology and content of the available ingredient of the IR material.

The above IR material may be a mixture of one or more of biochar, tourmaline ([Na,K,Ca][Mg,F,Mn,Li,Al]₃[Al,Cr,Fe,V]₆[BO₃]₃[Si₆O₁₈][OH,F]₄), far-infrared (far-IR) ceramic, jade powder, aluminum oxide, copper(II) oxide, silver(I,III) oxide and silicon carbide. The particle size of the IR material may be for example in the order of a nanometer to a micrometer.

As shown in FIG. 1, the IR layer 4 may be disposed (such as via sputtering and other coating methods) between the cover plate 1 and the touch sense layer 2. For example, the IR layer 4 is disposed on a surface of the touch sense layer 2 that faces the cover plate 1. The disposition may be realized by using the following method:

coating the OCR on the touch sense layer 2;

pre-curing the coated OCR;

coating the IR layer 4 on the pre-cured OCR;

disposing the cover plate 1 on the IR layer 4 and having the cover plate 1 and the IR layer 4 aligned; and

ultraviolet (UV) curing to form the touch panel.

As another example, the IR layer 4 may also be disposed on a surface of the cover plate 1 that faces the touch sense layer 2. The disposition may be realized in the following way:

coating and pre-curing the IR layer 4 on a surface of the cover plate 1 that faces the touch sense layer 2;

coating the OCR on the cured IR layer 4;

pre-curing the coated OCR;

disposing the cover plate 1 on the touch sense layer 2 and having them aligned by placing the side having the IR layer 4 facing the touch sense layer 2; and

UV curing to form the touch panel.

Other than the method of disposing the IR layer 4 between the cover plate 1 and the touch sense layer 2 as shown in FIG. 1, in other examples of the invention, the IR layer 4 may also be disposed between the touch sense layer 2 and the display unit layer 3. For example, the IR layer 4 is disposed on a surface of the touch sense layer 2 that faces the display unit layer 3, or on a surface of the display unit layer 3 that faces the touch sense layer 2.

It is thus seen that the IR layer 4 may be disposed on one or more components comprising the cover plate 1, the touch sense layer 2, and the display unit layer 3 shown in FIG. 1, or even on other components provided in the touch panel. Moreover, in terms of one component, the IR layer 4 may be coated on the whole surface of the component or on a part of the surface of the component, such that the part of the surface can emit IR light or the intensity of the IR light in the part of the surface can be enhanced.

Another embodiment of the invention further provides a touch panel, in which the IR material may be doped into the raw material of at least one of the individual components of the touch panel while fabricating the components, no matter the touch panel has or has not the IR layer 4. For example, the IR material is doped into the raw material of at least one of the following components: the cover plate 1, the touch sense layer 2, and the display unit layer 3. As an example, the IR material may also be mixed into the OCR in the touch panel, for example by using the following method:

uniformly mixing the IR material in the OCR according to a proportion;

coating the ORC having the IR material mixed therein on the touch sense layer 2;

pre-curing the coated OCR;

disposing the cover plate 1 on the touch sense layer 2 and having them aligned; and

UV curing to form the touch panel.

Moreover, the IR material may be surface modified, such that the IR material is compatible and has optimal matching property with the corresponding structure of the touch panel, so as to prevent the introduction of the IR material from affecting the performance of the LCD. The purpose of the surface modification is to modify the surface morphology, grain boundary structure of the IR material, such that the IR material can be compatible with the corresponding structure of the touch panel and does not harm the performance of the touch panel. Meanwhile, a further purpose of the surface modification is to change the activity of the IR material and to improve the heat exchange capacity by modifying the surface morphology, grain boundary structure of the IR material, such that the far-IR light of a specific wavelength is emitted with higher emissivity.

Still another embodiment of the invention provides a surface modification method for an IR material, the method comprises the following steps:

1) nanocrystallizing the IR material to obtain nanoparticles of the IR material; and

2) modifying surface property of the nanocrystallized nanoparticles such that the nanoparticles are compatible and have matching property with a structural layer of a liquid crystal cell and emit IR light when being irradiated.

The purpose of step 1) is to nanocrystallize the IR material to obtain the nanoparticles of the IR material. For fabricating nanomaterial, conventional grinding and dispersion methods may be used, for example, in an organic solvent by using a conventional grinding device (such as a ball mill, a sand mill or the like) and a dispersant. A weight percentage of the IR material in the nano dispersion solution may be 10˜15%. As an example, the step 1) comprises grinding and dispersing the IR material to obtain a nano dispersion solution of the IR material with an average particle size of 1 nm to 200 nm.

The purpose of step 2) is to modify the surface property of the nanocrystallized nanoparticles such that the IR material is compatible with the corresponding structure of the liquid crystal cell and does not harm the performance of the display device. Meanwhile, a further purpose of the step 2) is to change the activity of the IR material and to improve the heat exchange capacity by further modifying the surface of the nanocrystallized IR material, such that the far-IR light of a specific wavelength is emitted with higher emissivity. As an example, the step 2) comprises:

mixing the dispersion solution of the IR material with an organic solution containing methyl methacrylate, styrene, maleimide, and then adding an azo-initiator solution into the mixture; and

after the reaction is finished, adding a cooling organic solvent to cool and stirring until resultant is cooled, then filtering and drying the resultant to obtain the surface modified IR material.

As another example, the step 2) comprises:

dissolving azo-initiator, such as 2,2′-Azobis-(2-methylbutyro nitrile), azobis isobutyro nitrile (AIBN), azobis isohexyl nitrile, 2,2′-Azobis isohepto nitrile or the like, in an organic solvent for further use;

placing the nano dispersion solution of the IR material in a 4-mouth flask and performing stirring, vibration (with a frequency of above 50 Hz) or shaking;

dissolving monomer including methyl methacrylate, styrene, and maleimide (the molar ratio of three monomer is 1:1˜2:1˜2/mol) in an organic solvent (with a volume ratio between the monomer and the organic solvent of 1:1˜1:3) and adding the obtained solution into the 4-mouth flask, wherein the IR material weights 8˜25%, preferably 10˜20%, and more preferably 12˜17%, of the total mixture weight;

an environmental condition for modifying the surface property of the nanocrystallized nanoparticles has a temperature of 35° C.˜60° C. and in a nitrogen atmosphere; the azo-initiator solution is added drop by drop with a weight of 1˜5% of total monomer weight into the 4-mouth flask, a reaction time for stirring, vibration or shaking is 30˜90 minutes;

after the reaction is finished, adding a cooling organic solvent of 5° C. to 10° C. to cool and stirring until resultant is cooled to room temperature;

after filtering the resultant for three times, washing the filtered solid using the aforementioned organic solution with dissolved monomer, and then drying at 70° C.˜100° C. for 5˜20 minutes to obtain the surface modified IR material.

The organic solvent used in the above method may be one or more of fatty alcohol, glycol ethers, ethyl acetate, methyl ethyl ketone (MEK), 4-methylpentan-2-one, monomethyl ether acetate glycol esters, γ-butyrolactone, propionic acid-3-ether acetate, butyl carbitol, butyl carbitol acetate, propylene glycol monomethyl ether, propylene glycol monomethyl ether acetate, cyclohexane, xylene and isopropanol.

The dispersant used in the above method may be a conventional dispersant, such as BYK 410, BYK 110, BYK 163, BYK 161, BYK 2000 or the like. A weight percentage of the dispersant in the nano dispersion solution is 5˜15%, preferably 7˜12%.

A further embodiment of the invention provides a liquid crystal cell, which has a component comprising an IR material disposed therein, the IR material is obtained using the above surface modification method.

A still further embodiment of the invention provides a LCD device comprising a backlight module and any one of the above liquid crystal cell. The LCD device can be a display of a portable electronic device such as a portable PC, a mobile phone, and an E-book. The LCD device may further comprise a display module, a backlight module, a front polarizer and a rear polarizer and the like.

As the touch panel in the above embodiments has a component comprising the IR material disposed therein, the touch panel can emit IR light having relatively strong penetration and radiation capabilities when being irradiated by the backlight module or ambient light (such as solar light) providing irradiation for the touch panel. When absorbed by the human body, the IR light may cause the in vivo water molecules to resonate, such that the water molecules are activated and the bonding force between the water molecules is increased. As a result, bio-macromolecules such as protein are activated and the bio-cells are in a higher vibrating energy level. As the bio-cells are resonating with each other, the far-IR thermal energy can be transferred to a deeper endermic location of the human body. The temperature at the deeper location therefore increases, and the generated heat is dissipated from inside toward outside, which will expand capillary vessels and facilitate blood circulation, thereby enhancing the metabolism between tissues, increasing regeneration capability of the tissues, and improving immune competence of the body. Such procedure is beneficial for the heath and can reduce the influence of electromagnetic radiation on the human body. Similarly, in the LCD device comprising the touch panel of the invention, the touch panel can emit IR light to the exterior of the LCD device when being irradiated by the backlight or ambient light (such as solar light), which makes the LCD device beneficial for the heath. Moreover, the surface modified IR material can realize compatibility and optimal performance matching with the touch panel structure, which will improve the heat exchange capability between the IR material and the backlight as well the ambient light without compromising the performance of the LCD device, and the surface modified IR material will emit far-IR light with higher emissivity.

What are described above is related to the illustrative embodiments of the disclosure only and not limitative to the scope of the disclosure; the scopes of the disclosure are defined by the accompanying claims.

1. A touch panel, wherein a component comprising an infrared (IR) material is disposed in the touch panel.

2. The touch panel of claim 1, wherein the component comprising the IR material is an IR layer made of the IR material.

3. The touch panel of claim 2, comprising a cover plate, a touch sense layer and a display unit layer,
wherein the IR layer is disposed between the cover plate and the touch sense layer; and/or
the IR layer is disposed between the touch sense layer and the display unit layer.

4. The touch panel of claim 3, when the IR layer is disposed between the cover plate and the touch sense layer,
the IR layer is disposed on a surface of the touch sense layer that faces the cover plate; or
the IR layer is disposed on a surface of the cover plate that faces the touch sense layer.

5. The touch panel of claim 3, when the IR layer is disposed between the touch sense layer and the display unit layer,
the IR layer is disposed on a surface of the touch sense layer that faces the display unit layer; or
the IR layer is disposed on a surface of the display unit layer that faces the touch sense layer.

6. The touch panel of claim 2, further comprising an optical clear resin layer disposed between the IR layer and the touch sense layer.

7. The touch panel of claim 1, wherein the component comprising the IR material comprises at least one of the following components: a cover plate, a touch sense layer, and a display unit layer.

8. The touch panel of claim 7, wherein an IR layer made of the IR material is disposed on all or a part of the surface of the at least one of the cover plate, the touch sense layer, and the display unit layer.

9. The touch panel of claim 1, comprising a cover plate, a touch sense layer and a display unit layer, wherein at least one of which is made of a material containing an IR material.

10. The touch panel of claim 1, wherein the IR material is a mixture of one or more of biochar, tourmaline, far-infrared ceramic, jade powder, aluminum oxide, copper(II) oxide, silver(I,III) oxide and silicon carbide.

11. The touch panel of claim 1, wherein a particle size of the IR material is in the order of a nanometer to a micrometer.

12. The touch panel of claim 1, wherein the IR material is surface modified so as to emit IR light when being irradiated.

13. A LCD device comprising a backlight module and the touch panel of claim 1.

14. A surface modification method for an IR material, comprising:
nanocrystallizing the IR material to obtain nanoparticles of the IR material;
modifying surface property of the nanocrystallized nanoparticles, such that the nanoparticles are compatible and have matching property with a corresponding structural layer of a liquid crystal cell and emit IR light when being irradiated by light.

15. The method of claim 14, wherein nanocrystallizing the IR material comprises grinding and dispersing the IR material to obtain a dispersion solution of the IR material with an average particle size of 1 nm to 200 nm.

16. The method of claim 15, wherein modifying surface property of the nanocrystallized nanoparticles comprises:
mixing the dispersion solution of the IR material with an organic solvent containing methyl methacrylate, styrene, maleimide, and then adding an azo-initiator solution into the mixture; and
after the reaction is finished, adding a cooling organic solvent to cool and stirring until resultant is cooled, then filtering and drying the resultant to obtain the surface modified IR material.

17. The method of claim 16, wherein the molar ratio between methyl methacrylate, styrene and maleimide is 1:1˜2:1˜2, the IR material weights 8˜25% of the total mixture weight; and the azo-initiator solution is added drop by drop with a weight of 1˜5% of total monomer weight.

18. The method of claim 16, wherein an environmental condition for modifying the surface property of the nanocrystallized nanoparticles has a temperature of 35° C.˜60° C. and in a nitrogen atmosphere;
a reaction time is 30 minutes to 90 minutes;
a temperature of the cooling organic solvent is 5° C. to 10° C.;
cooling is performed till room temperature;
filtering is performed for three times; and
drying is performed for 5 minutes to 20 minutes at 70° C. to 100° C.

19. A touch panel, wherein a component comprising an infrared (IR) material is disposed in the touch panel, the IR material is obtained using the surface modification method of claim 14.
